(19) United States
(12) Patent Application Publication
(10) Pub. No.: US 2023/0253687 A1
(43) Pub. Date: Aug. 10, 2023

(54) BATTERY MODULE FOR A VEHICLE

(71) Applicants: HYUNDAI MOTOR COMPANY, Seoul (KR); KIA CORPORATION, Seoul (KR)

(72) Inventor: Hyun Chang Kang, Seoul (KR)

(73) Assignees: HYUNDAI MOTOR COMPANY, Seoul (KR); KIA CORPORATION, Seoul (KR)

(21) Appl. No.: 17/894,228

(22) Filed: Aug. 24, 2022

(30) Foreign Application Priority Data
Feb. 4, 2022 (KR) 10-2022-0014928

(51) Int. Cl. H01M 50/569; H01M 50/213; H01M 50/291; H01M 50/262; H01M 50/51; H01M 10/48; H01M 50/271

(52) U.S. Cl. CPC H01M 50/569; H01M 50/213; H01M 50/291; H01M 50/262; H01M 50/51; H01M 10/482; H01M 50/271; H01M 2220/20

(57) ABSTRACT

Disclosed is a battery module for a vehicle. In particular, the battery module includes: a plurality of cylindrical battery cells having electrodes, each of the electrodes being provided on a corresponding one of opposite ends thereof, a case configured to surround and accommodate cylindrical portions of the plurality of battery cells so that the electrodes of the battery cells are disposed in the same plane, and a sensing block including a bus bar configured to electrically connect the electrodes of the battery cells, the sensing block being installed to restrain the battery cells accommodated in the case.

### CROSS-REFERENCE TO THE RELATED APPLICATION

This application claims priority to and the benefit of Korean Patent Application No. 10-2022-0014928, filed on Feb. 4, 2022, the entire contents of which are incorporated herein by reference.

### BACKGROUND

### 1. Field

The present disclosure relates to a structure of a battery module mounted in a vehicle.

### 2. Description of the Related Art

A battery module mounted in a vehicle is configured to combine a plurality of battery cells, thereby outputting a desired voltage.

In the related art, a pouch-type battery cell is mainly used. Since it is difficult to secure the structural rigidity of the pouch-type battery cell, many components are required to stably support a plurality of cells, which results in an increase in the number of components and an increase in the volume of the battery module.

The information disclosed in this Background of the Present disclosure section is only for enhancement of understanding of the general background of the present disclosure, and should not be taken as an acknowledgement or any form of suggestion that this information forms the related art already known to a person of ordinary skill in the art.

### SUMMARY OF THE PRESENT DISCLOSURE

The present disclosure provides a battery module for a vehicle. In particular, the battery module includes a plurality of cylindrical battery cells and is configured to enable a simple assembly with a relatively small number of components and provide strong structural rigidity such that the battery module is reliably used in a vehicle environment subjected to repeated vibration and impact.

In one embodiment of the present disclosure, a battery module for a vehicle may include: a plurality of cylindrical battery cells having electrodes, each of the electrodes being provided on a corresponding one of opposite ends thereof, a case configured to surround and accommodate cylindrical portions of the plurality of battery cells so that the electrodes of the battery cells are disposed in the same plane, and a sensing block including at least one bus bar configured to electrically connect the electrodes of the battery cells. In particular, the sensing block is installed to restrain the battery cells accommodated in the case.

In another embodiment, the case may include a plurality of support protrusions, provided therein and configured to protrude toward each battery cell, to avoid surface contact with the cylindrical portion of each battery cell and to support each battery cell by point contact or line contact at two or more positions thereof.

The case may include: an upper side configured to be open to receive the battery cells to be inserted thereinto in a longitudinal direction of the battery cells; and a lower side configured to be open to allow the electrodes of the battery cells to be exposed. In particular, the lower side includes a locking protrusion formed thereon and is configured to prevent the battery cells from passing therethrough.

In another embodiment, the battery cells inserted into the case may be disposed in a line so that adjacent electrodes thereof have opposite polarities from each other, and the bus bars in the sensing block may be configured to connect all of the battery cells inserted into the case in series.

Each of the bus bars may be connected to a corresponding one of sensing wires, each of the sensing wires sensing a voltage of a corresponding battery cell, and the sensing wires may be connected to a sensing connector fixed to an outside of the case.

The sensing block may include an opening to expose the electrode of each battery cell, and the bus bar may protrude from the sensing block toward the battery cell so as to be in close contact with the electrode of the battery cell through the opening.

The four battery cells may be inserted into the case in a line, the sensing block may be two sensing blocks respectively provided on the upper side of the case and on the lower side thereof, the four openings may be disposed in a line in the sensing block on the upper side thereof, and the bus bar provided in the sensing block on the upper side thereof may be formed of a first bus bar, connected to the electrodes of the two central battery cells through the two openings in the center of the four openings, and a second bus bar and a third bus bar, each of which is connected to a corresponding one of the electrodes of the battery cells at opposite ends through the two outermost openings among the four openings and is connected to a corresponding one of output terminals.

The four openings may be disposed in a line in the sensing block on the lower side thereof, and the bus bar provided in the sensing block on the lower side thereof may be formed of a fourth bus bar, connected to the electrodes of the two battery cells on one side through the two adjacent openings to one side among the four openings, and a fifth bus bar, connected to the electrodes of the two battery cells on the other side through the two adjacent openings to the other side among the four openings.

Each of the sensing wires may be connected, from the sensing connector, to a corresponding one of the first bus bar to the fifth bus bar.

The opening in the sensing block on the upper side of the case may accommodate the electrode protruding upwards from the battery cell, and a portion other than the opening may be formed to keep an upper end of the battery cell in the case.

the sensing block may be two sensing blocks respectively provided on the upper side of the case and on the lower side thereof, a block connection unit may be provided between the sensing block on the upper side thereof and the sensing block on the lower side thereof, and the sensing block on the upper side thereof and the sensing block on the lower side thereof may be formed to be integrated with each other by the block connection unit.

The sensing block on the upper side, the block connection unit, and the sensing block on the lower side may be connected to each other by a bending line, the bending line having a portion having a small cross-sectional thickness and being interposed therebetween, so as to be folded onto each other.

The sensing block on the upper side thereof and the sensing block on the lower side thereof may be coupled to the case in a snap-fit manner.

The battery module may further include a module cover configured to surround the sensing block.

### BRIEF DESCRIPTION OF THE DRAWINGS

The above and other objects, features and other advantages of the present disclosure should be more clearly understood from the following detailed description taken in conjunction with the accompanying drawings, in which:

FIG. 1 is an external view of a battery module for a vehicle according to one embodiment of the present disclosure;

FIG. 2 is an exploded perspective view of the battery module of FIG. 1;

FIG. 3 is a view showing the state in which cylindrical battery cells are inserted into a case of the battery module;

FIG. 4 is a cross-sectional view taken along the line IV-IV of FIG. 3;

FIG. 5 is a cross-sectional view taken along the line V-V of FIG. 3;

FIG. 6 is a view showing the structure of a sensing block in a cross section taken along the line VI-VI of FIG. 3;

FIG. 7 is a view showing the structure of the sensing block;

FIG. 8 is a view showing the electrode direction of each of the battery cells, a bus bar connection state, and a sensing wire connection structure in the cross-section of FIG. 6;

FIG. 9 is a cross-sectional view taken along the line IX-IX of FIG. 1;

FIG. 10 is a view showing an example in which an upper sensing block and a lower sensing block are formed to be integrated with each other and to be connected to a block connection unit;

FIG. 11 is a view showing a process whereby the sensing blocks of FIG. 10 are installed in a case; and

FIG. 12 is a view showing a structure in which the sensing blocks of FIG. 10 are installed in the case.

The drawings described herein are for illustration purposes only and are not intended to limit the scope of the present disclosure in any way.

### DETAILED DESCRIPTION

Specific structural or functional descriptions made in connection with the embodiments of the present disclosure or application are merely illustrative for the purpose of describing embodiments according to the present disclosure. Further, the present disclosure may be implemented in various forms, and should not be construed as being limited to the embodiments described in the present disclosure.

Since the embodiments according to the present disclosure may be variously modified and may have various forms, specific embodiments are illustrated in the drawings and described in detail in this specification . However, it should be understood that the embodiments according to the concept of the present disclosure are not intended to be limited to the specific disclosed forms, and include all modifications, equivalents, and substitutes that fall within the spirit and technical scope of the present disclosure.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween. Other expressions for the description of relationships between components, such as, “between” and “directly between” or “adjacent to” and “directly adjacent to”, should be interpreted in the same manner.

The terms used in the specification are only used to describe specific embodiments, and are not intended to limit the present disclosure. In this specification, an expression in a singular form also includes the plural sense, unless otherwise clearly specified in context. It should be understood that expressions such as “comprise” and “have” in this specification are intended to designate the presence of indicated features, numbers, steps, operations, components, parts, or combinations thereof, but do not exclude the presence or addition of one or more features, numbers, steps, operations, components, parts, or combinations thereof.

Unless otherwise defined, all terms used herein, including technical and scientific terms, have the same meanings as those commonly understood by those having ordinary skill in the art to which the present disclosure pertains. Terms such as those defined in commonly used dictionaries should be interpreted as having meanings consistent with their meanings in the context of the related technology. Further, unless explicitly defined in this specification, the terms should not be interpreted in an ideal or overly formal sense.

When a component, device, element, or the like of the present disclosure is described as having a purpose or performing an operation, function, or the like, the component, device, or element should be considered herein as being “configured to” meet that purpose or to perform that operation or function.

Hereinafter, the present disclosure is described in detail by describing embodiments thereof with reference to the accompanying drawings. The same reference numerals in each drawing represent the same members.

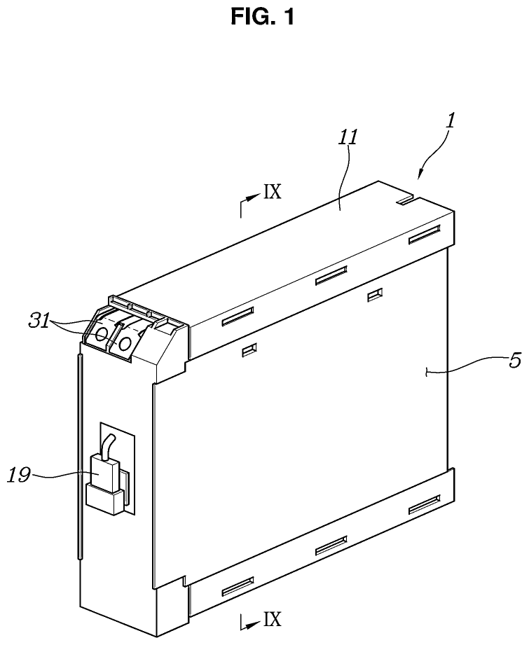

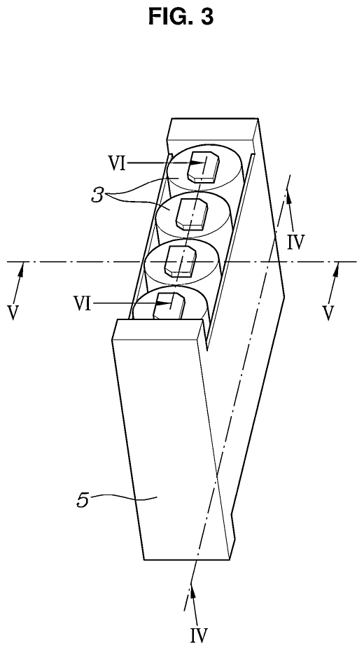

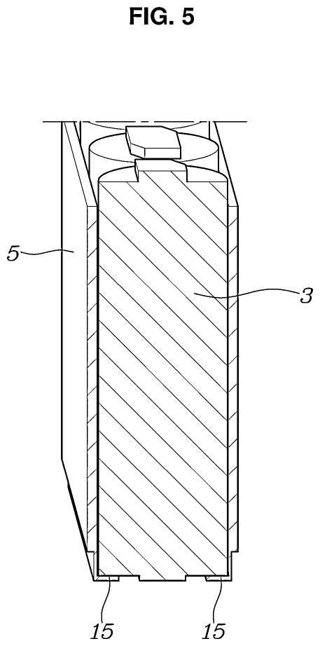

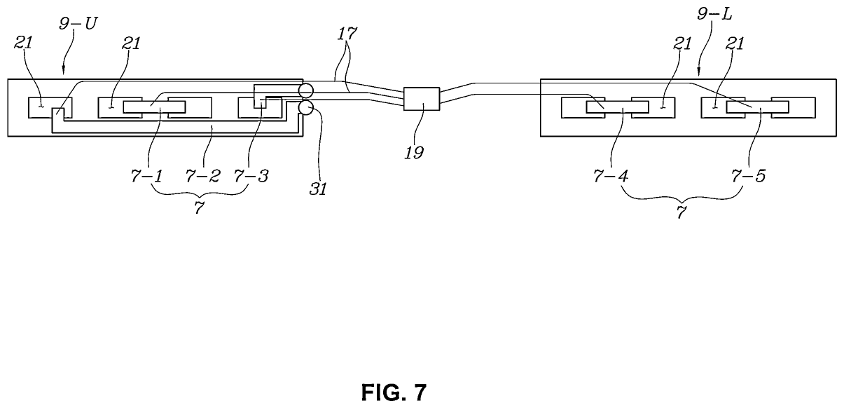

Referring to FIGS. 1 to 12, a battery module 1 for a vehicle according to an embodiment of the present disclosure includes a plurality of cylindrical battery cells 3 having electrodes, each of the electrodes being provided on a corresponding one of opposite ends thereof, a case 5 configured to surround and accommodate cylindrical portions of the plurality of battery cells 3 so that the electrodes of the battery cells 3 are disposed in the same plane, a sensing block 9 including a bus bar 7 configured to electrically connect the electrodes of the battery cells 3, and a module cover 11 configured to surround the sensing block 9. In particular, the sensing block 9 is installed to restrain the battery cells 3 accommodated in the case 5.

In one embodiment, the plurality of cylindrical battery cells 3 are accommodated in the case 5, an electric circuit is formed by connecting the electrodes of the battery cells 3 with the bus bar 7 in the sensing block 9, and the module cover 11 is configured to protect the electric circuit from the outside.

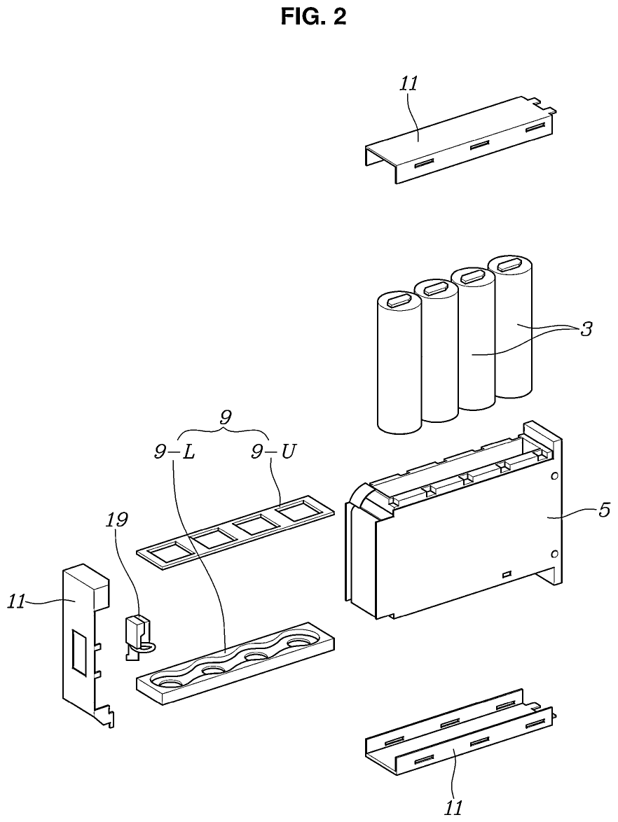

For reference, as shown in FIG. 1, the module cover 11 may be implemented in a form that integrally surrounds an upper side, a lower side, and side surfaces of the case 5. Alternatively, as shown in FIG. 2, three module covers 11 may be separately provided to surround the upper side, the lower side, and the side surfaces thereof.

In another embodiment, the case 5 includes a plurality of support protrusions 13 and the support protrusions 13 protrude toward the battery cell 3 such that the case 5 is configured to avoid surface contact with the cylindrical portion of the battery cell 3 and to support each battery cell 3 by point contact or line contact at two or more positions thereof.

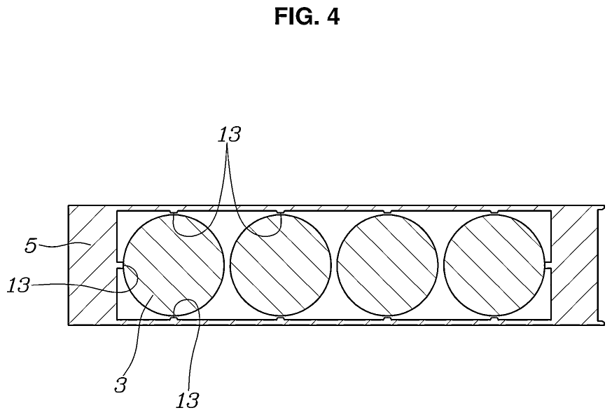

As shown in FIG. 4, because a plurality of support protrusions 13 protrude from the inner surface of the case 5, the support protrusions 13 prevent the battery cell 3 from coming into surface contact with the inner surface of the case 5. In addition, a sufficient space between the battery cell 3 and the case 5 is secured to allow moisture to flow between the battery cell 3 and the case 5, thereby preventing condensation of moisture and also preventing an electrical short-circuit of the battery cells 3 as far as possible.

The case 5 has an upper side, configured to be open to allow the battery cell 3 to be inserted thereinto in the longitudinal direction of the battery cell 3, and a lower side, configured to be open to allow the electrode of the battery cell 3 to be exposed, the lower side having a locking protrusion 15 formed thereon and configured to prevent the battery cell 3 from passing therethrough.

Accordingly, when the battery cells 3 are inserted into the case 5 from the upper side thereof, the battery cells 3 are automatically restrained on the lower side of the case 5. Accordingly, it is not required to include an additional component configured to prevent separation of the battery cell 3 or an additional component configured to prevent the same from moving.

In addition, the case 5 is formed of a single component that completely surrounds the cylindrical portion of the battery cells 3 as described above, and the lower and upper sides of the case 5 are surrounded by the sensing block 9 and the module cover 11, thereby making it possible to form the battery module 1 having high structural rigidity.

The battery cells 3 inserted into the case 5 are disposed in a line so that adjacent electrodes thereof have opposite polarities from each other, and the bus bars 7 in the sensing block 9 are configured to connect all of the battery cells 3 inserted into the case 5 in series.

Further, each of the bus bars 7 is connected to a corresponding one of the sensing wires 17, each of which is configured to sense the voltage of a corresponding battery cell 3, and the sensing wires 17 are connected to a sensing connector 19 fixed to the outside of the case 5.

In one form, the sensing connector 19 is connected to a battery management system (BMS), thereby measuring the voltage of each of the battery cells 3 in the case 5.

The sensing block 9 includes an opening 21 to expose the electrode of each battery cell 3, and the bus bar 7 protrudes from the sensing block 9 toward the battery cell 3 so as to be in close contact with the electrode of the battery cell 3 through the opening 21.

The sensing block 9 is made of a material such as plastic, and the bus bar 7 is integrally coupled thereto through thermal fusion.

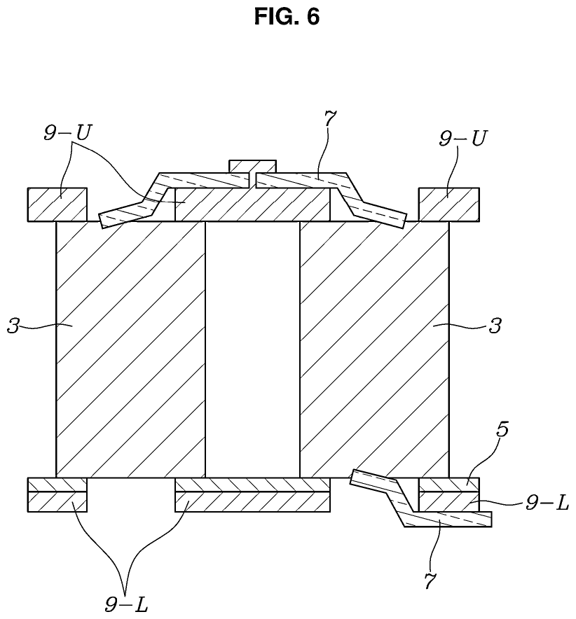

FIG. 6 shows the state in which the bus bar 7 in the sensing block 9 partially invades the upper and lower ends of the battery cell 3, but this state is shown on the assumption that the battery cell 3 is not present in the case 5. In the state in which the battery cell 3 is present in the case 5, the bus bar 7 is provided in the sensing block 9 so as to be in close contact with the electrode of the battery cell 3.

Therefore, when the bus bar 7 is welded to the battery cell 3, easy and strong welding may be performed.

In the embodiment, the four battery cells 3 are inserted into the case 5 in a line, each of the sensing blocks 9 is provided on the upper side of the case 5 and the lower side thereof, and four openings 21 are disposed in a line in an upper sensing block 9-U.

The bus bar 7 provided in the upper sensing block 9-U is formed of a first bus bar 7-1 connected to the electrodes of the two central battery cells 3 through the two openings in the center of the four openings 21, and a second bus bar 7-2 and a third bus bar 7-3, each of which is connected to a corresponding one of the electrodes of the battery cells 3 at opposite ends through the two outermost openings among the four openings 21 and is connected to a corresponding one of output terminals 31.

In addition, the four openings 21 are disposed in a line in a lower sensing block 9-L. The bus bar 7 provided in the lower sensing block 9-L is formed of a fourth bus bar 7-4, connected to the electrodes of the two battery cells 3 on one side through the two adjacent openings to one side among the four openings 21, and a fifth bus bar 7-5, connected to the electrodes of the two battery cells 3 on the other side through two adjacent openings to the other side among the four openings 21.

Further, each of the sensing wires 17 is connected, from the sensing connector 19, to a corresponding one of the first bus bar 7-1 to the fifth bus bar 7-5.

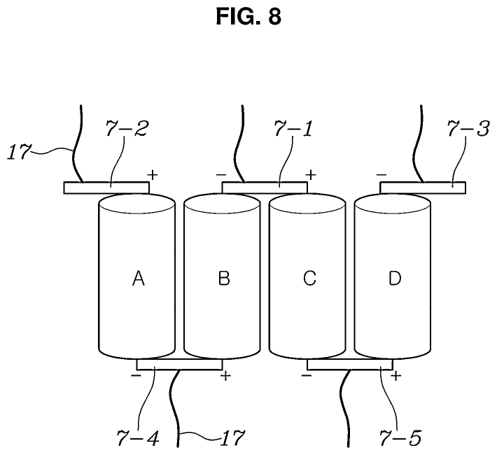

Accordingly, the battery cells 3, the bus bars 7, and the sensing wires 17 accommodated in the case 5 implement the state shown in FIG. 8. Here, the voltage of a battery cell A may be measured through the sensing wires 17, each of which is connected to the second bus bar 7-2 and the fourth bus bar 7-4, the voltage of a battery cell B may be measured through the sensing wires 17, each of which is connected to the first bus bar 7-1 and the fourth bus bar 7-4, the voltage of a battery cell C may be measured through the sensing wires 17, each of which is connected to the first bus bar 7-1 and the fifth bus bar 7-5, and the voltage of a battery cell D may be measured through the sensing wires 17, each of which is connected to the third bus bar 7-3 and the fifth bus bar 7-5.

Of course, measurement of the voltage of each battery cell 3 as described above is performed by the BMS connected to the sensing connector 19.

In the upper sensing block 9-U, the opening 21 accommodates the electrode protruding upwards from the battery cell 3, and a portion other than the opening 21 is formed to hold the upper end of the battery cell 3 in the case 5.

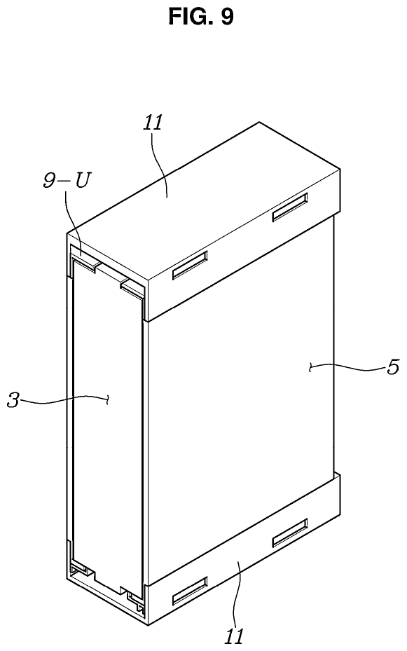

That is, as shown in FIG. 9, on the lower side of the case 5, the locking protrusion 15 is provided to prevent the battery cells 3 from being separated from the case 5 and moving therein. On the upper side thereof, the upper sensing block 9-U serves to prevent the battery cells 3 from being separated from the case 5 and moving therein.

In order to enable the sensing block 9 to restrain the battery cells 3 as described above, the sensing block 9 is desired to be firmly fixed to the case 5. As described below, the sensing block 9 may be firmly fixed to the case 5 in a snap-fit manner.

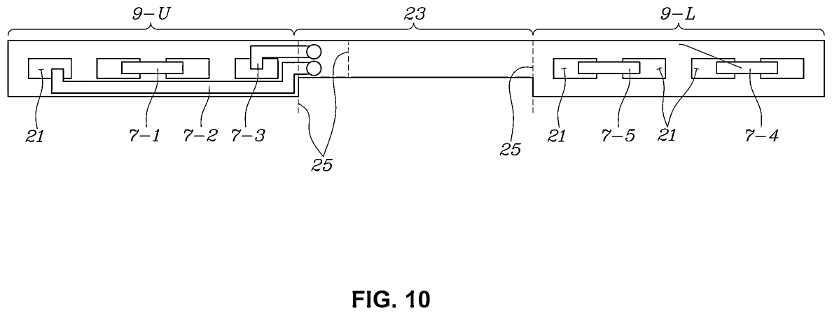

FIG. 10 shows another embodiment of implementation of the sensing block 9. A block connection unit 23 is provided between the upper sensing block 9-U and the lower sensing block 9-L. The upper sensing block 9-U and the lower sensing block 9-L are formed to be integrated with each other by the block connection unit 23.

That is, the upper sensing block 9-U, the block connection unit 23, and the lower sensing block 9-L are connected to each other by a bending line 25, the bending line 25 having a portion having a small cross-sectional thickness and being interposed therebetween, so as to be sequentially folded onto each other. More specifically, the bending line 25 is interposed between the upper sensing block 9-U and the block connection unit 23, and is interposed between the block connection unit 23 and the lower sensing block 9-L.

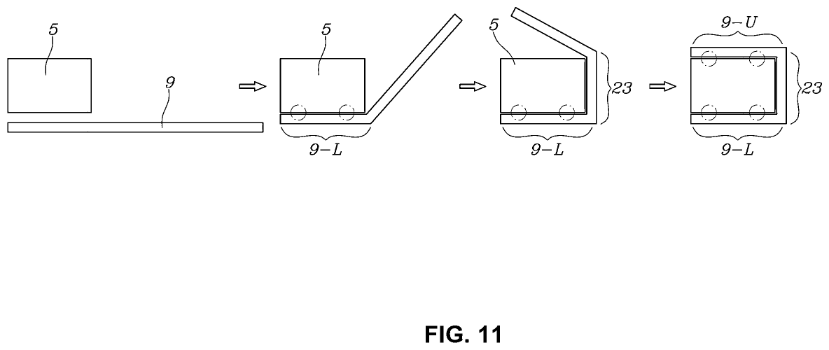

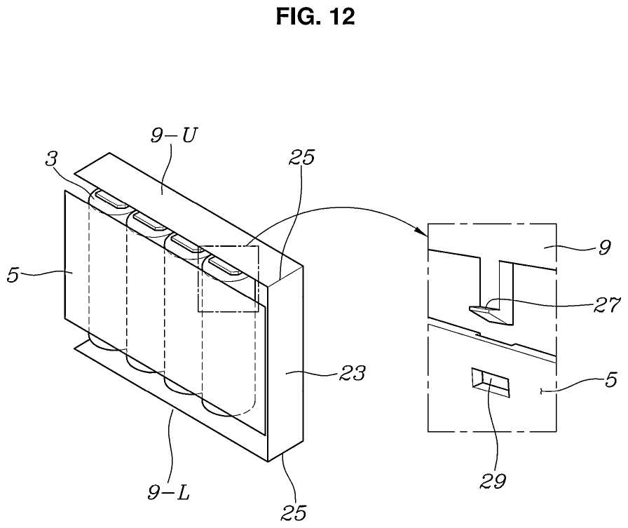

When the sensing block 9 is made of a plastic-like material and is provided with the banding line 25 having a portion having a small cross-sectional thickness, it is possible to easily bend the portion at which the bending line 25 is located. Accordingly, as shown in FIGS. 11 and 12, the upper sensing block 9-U and the lower sensing block 9-L may be easily coupled to the case 5.

That is, as shown in FIG. 11, the portion of the lower sensing block 9-L is coupled to the lower side of the case 5 in a snap-fit manner. Next, the block connection unit 23 is bent, and the upper sensing block 9-U is coupled to the upper side of the case 5 in a snap-fit manner, thereby completing assembly of the sensing block 9.

The above-described coupling therebetween using the snap-fit manner may be performed by forming a snap protrusion 27 on the sensing block 9 and a snap hole 29 in the case 5, as shown in FIG. 12.

As described above, when the upper sensing block 9 and the lower sensing block 9 are formed to be integrated with each other while being connected to the block connection unit 23, components may be simplified. Accordingly, handling of the components and assembly thereof may be improved.

For reference, in FIG. 10, two bending lines are formed adjacent to each other near the output terminal 31 to form a chamfer shape at a portion where the output terminal 31 is positioned, as shown in FIG. 1, which is not shown in FIGS. 11 and 12.

Additionally, in FIG. 11, the portion indicated by the dotted circle represents a portion fastened in a snap-fit manner.

As is apparent from the above description, the present disclosure provides a battery module having a plurality of cylindrical battery cells, configured to provide a simple assembly with a relatively small number of components, to provide strong structural rigidity, and to be reliably used in a vehicle environment subjected to repeated vibration and impact.

Although the embodiments of the present disclosure have been disclosed for illustrative purposes, those having ordinary skill in the art should appreciate that various modifications, additions and substitutions are possible, without departing from the scope and spirit of the present disclosure.

What is claimed is:

1. A battery module for a vehicle, the battery module comprising:
a plurality of battery cells having electrodes, each of the electrodes being provided on a corresponding one of opposite ends thereof;
a case configured to surround and accommodate cylindrical portions of the plurality of battery cells so that the electrodes of the plurality of battery cells are disposed in the same plane; and
a sensing block comprising at least one bus bar configured to electrically connect the electrodes of the plurality of battery cells, the sensing block being installed to restrain the plurality of battery cells accommodated in the case.

2. The battery module according to claim 1, wherein the case comprises a plurality of support protrusions configured to respectively protrude toward battery cells of the plurality of battery cells, and
wherein the case is configured to avoid a surface contact with the cylindrical portion of each battery cell of the plurality of battery cells and support each battery cell by a point contact or a line contact at two or more positions thereof.

3. The battery module according to claim 1, wherein the case includes: an upper side configured to be open to receive the battery cells in a longitudinal direction of the battery cells, and a lower side configured to be open to allow the electrodes of the battery cells to be exposed, and
wherein the lower side includes a locking protrusion formed thereon, and the locking protrusion is configured to prevent the battery cells from passing therethrough.

4. The battery module according to claim 3, wherein:
the battery cells inserted into the case are disposed in a line so that adjacent electrodes thereof have opposite polarities from each other, and
the at least one bus bar in the sensing block is configured to connect all of the battery cells inserted into the case in series.

5. The battery module according to claim 4, wherein:
the at least one bus bar is connected to a corresponding one of sensing wires, each of the sensing wires configured to sense a voltage of a corresponding battery cell among the battery cells, and
the sensing wires are connected to a sensing connector fixed to an outside of the case.

6. The battery module according to claim 4, wherein:
the sensing block comprises an opening to expose the electrode of each battery cell, and
the at least one bus bar protrudes from the sensing block toward the battery cells so as to be in close contact with the electrodes of the battery cells through the opening.

7. The battery module according to claim 6, wherein:
four battery cells of the plurality of battery cells are inserted into the case in a line,
the sensing block is respectively provided on the upper side of the case and on the lower side thereof,
four openings are disposed in a line in the sensing block on the upper side thereof, and
the at least one bus bar includes:
a first bus bar provided in the sensing block on the upper side thereof and connected to the electrodes of two central battery cells, among the plurality of battery cells, through two openings of the four openings, and
a second bus bar and a third bus bar, each of which is connected to a corresponding one of the electrodes of the battery cells at opposite ends through two outermost openings among the four openings and is connected to a corresponding one of output terminals.

8. The battery module according to claim 7, wherein:
the four openings are disposed in a line in the sensing block on the lower side thereof, and
the at least one bus bar further includes:
a fourth bus bar provided in the sensing block on the lower side thereof and connected to the electrodes of the two battery cells on one side through two adjacent openings to one side among the four openings, and
a fifth bus bar connected to the electrodes of the two battery cells on an other side through the two adjacent openings to the other side among the four openings.

9. The battery module according to claim 8, wherein each of sensing wires is connected, from a sensing connector, to a corresponding bus bar among the first, second, third, fourth and fifth bus bars.

10. The battery module according to claim 7, wherein the opening in the sensing block on the upper side of the case accommodates an electrode protruding upwards from a battery cell among the plurality of the battery cells, and a portion other than the opening is formed to keep an upper end of the battery cell in the case.

11. The battery module according to claim 6, wherein:
the sensing block is provided on each of the upper side of the case and the lower side thereof,
a block connection unit is provided between the sensing block on the upper side thereof and the sensing block on the lower side thereof, and
the sensing block on the upper side thereof and the sensing block on the lower side thereof are formed to be integrated with each other by the block connection unit.

12. The battery module according to claim 11, wherein the sensing block on the upper side, the block connection unit, and the sensing block on the lower side are connected to each other by a bending line, the bending line having a portion having a small cross-sectional thickness and being interposed therebetween, so as to be folded onto each other.

13. The battery module according to claim 12, wherein the sensing block on the upper side thereof and the sensing block on the lower side thereof are coupled to the case in a snap-fit manner.

14. The battery module according to claim 1, further comprising a module cover configured to surround the sensing block.
